(19) United States
(12) Patent Application Publication
(10) Pub. No.: US 2001/0056472 A1
(43) Pub. Date: Dec. 27, 2001

(54) System and method for public participation in space missions

(76) Inventor: Charles M. Chafer, Houston, TX (US)

Correspondence Address: George T. Marcou, Kilpatrick Stockton LLP, Suite 800, 700 - 13th Street, N.W., Washington, DC, 20005, US

(21) Appl. No.: 09/811,541

(22) Filed: Mar. 20, 2001

Related U.S. Application Data
(60) Provisional application No. 60/228,759, filed on Aug. 30, 2000.

(51) Int. Cl. G06F 15/16; H04H 1/00; H04N 7/173

(52) U.S. Cl. 709/217; 725/105; 455/3.01; 705/1; 709/201

(57) ABSTRACT

A novel method and system for public participation in space missions is provided. The method preferably includes creating an interactive web site for public input of information to be contained on the space mission and/or for public viewing on online broadcasting of the space mission. Preferably, the space mission includes a section within a spacecraft for storing information and/or material (e.g., body material containing genetic information, such as hair, skin or the like) away from the earth along with the spacecraft. The present invention provides significant advantages over existing methods related to space missions and significantly enhances the development of space missions and technology.

This application claims priority to Provisional Application No. 60/228,759,

filed Aug. 30, 2000. The disclosure of said Provisional Application is incorporated by reference in its entirety as though recited herein in full.

The present invention is related to applicant's co-pending provisional patent application entitled Spacecraft Advertisement Method And System and to applicant's co-pending provisional patent application entitled Method And System for Generating Revenues in Space Missions, both of which applications are to the present inventive entity and have the same filing date of the present application, the entire disclosures of which are incorporated herein by reference.

### BACKGROUND OF THE INVENTION

1. Field of the Invention

The present invention relates to methods and systems for public participation in space missions and the preferred embodiments provide, for example, public participation over an on-line computer network such as the Internet.

2. Description of the Related Art

Historically, the only entities that participated in real space missions were “governments” and large “corporations.” It is well known that space missions are very expensive. For this, and other reasons, individuals and other members of the public have not historically participated in space missions.

This separation of space missions from members of the public does not foster public support of space missions. This separation, thus, presents a barrier to rapid advancements in space flight, and, hence, to rapid advancements in technology and in society in general.

There remains a substantial need to bring space missions more directly to members of the public as real participants in such missions. Despite the high costs of space travel, the assignee of the present invention, Encounter 2001, LLC (see http://www.encounter2001.com), is bringing real space missions more directly to the public as participants in actual space missions. In addition, Celestis, Inc., an affiliate of Encounter 2001, LLC has successfully launched cremation burial space flights—e.g., including space burials of the famous celebrities Timothy Leary and Gene Roddenberry.

By creating new methods and systems to enable members of the public to contribute as real participants in actual space missions, the present assignee strives to, among other things, foster advancements in space flight, in technology and in society in general.

### SUMMARY OF THE INVENTION

The present invention overcomes various limitations related to existing space missions.

According to one embodiment of the invention, a method of public participation in a space mission includes: providing a web site or other graphical user interface for members of the public to access via the Internet or another computer network; having a public participant input data via a dynamic web page of the web site; altering a mission of a space vehicle in response data received as input from the public participant.

According to another embodiment of the invention, a method of public participation in a space mission includes: providing a server programmed to create a web site or graphical user interface accessible via the Internet or a computer network; providing a spacecraft having a public participation section; obtaining video images of said spacecraft during travel of said spacecraft on a space mission; creating an Internet or computer network broadcast of said video images; having a member of the public access and view said broadcast via a local computer over the Internet or computer network.

According to another embodiment of the invention, a method of public participation in a space mission includes: providing a server programmed to create a web site or graphical user interface accessible via the Internet or a computer network; having a member of the public access the web site via the Internet or computer network at a local computer remote from the server; having said member of the public input information via said web site; providing a spacecraft having a public participation section; physically storing said information submitted by said member of the public in said public participation section of said space craft; and launching said spacecraft away from the earth's surface.

The above and other aspects, features and advantages of the invention will be further appreciated in view of the following description of the preferred embodiments of the invention.

### BRIEF DESCRIPTION OF THE DRAWINGS

The present invention is shown by example and not limitation in the accompanying Figures, in which:

FIG. 1 is a schematic diagram of a spacecraft having an advertisement distant from the earth's surface;

FIG. 2(A) is a schematic diagram of a spacecraft having a solar sail;

FIG. 2(B) is a schematic diagram of a solar sail having an advertisement thereon;

FIG. 3 is a schematic diagram of a spacecraft and carriercraft system including multiple on-board components and revenues sources;

FIG. 4 is a schematic diagram of a system for presenting an interactive web site for public participation in space missions;

FIG. 5 is an illustrative web page that may be displayed on local computers or the like for signing up to participate in space missions; and

FIG. 6 is another illustrative web page that may be displayed on local computers or the like for viewing space mission progress, viewing delayed or real time video images or static images of space missions, communicating with other individuals, rendering purchases, and otherwise participating in space missions.

### DETAILED DESCRIPTION OF THE PREFERRED EMBODIMENTS

### Public Participation In Space Missions

In the preferred embodiments of the invention, a spacecraft is used for a public participation space mission. Preferably, members of the public can render payments in order to act as participants in the space mission. For example, by contributing $X dollars, members of the public may be able to provide data, images, statements, material, objects or other information or the like that is carried upon a spacecraft and/or members of the public may be able to participate in various on-line activities made available over a computer network such as the Internet. In some preferred embodiments, material to be provided by individuals includes physical body material, such as skin samples, hair samples or the like, having substantially intact genetic information and/or DNA information that may enable advanced cultures to learn about and/or to clone humans.

Preferably, the public participation component of the space mission is only one component of the entire space mission. For example, the spacecraft and/or a carriercraft which carries and transports the spacecraft from the earth's surface preferably contains government, scientific and/or other cargo, experiments and the like.

### Computer Network Interface (e.g., Web Site)

In preferred embodiments, an Internet web site or other on-line graphical user interface is provided which includes, for example, on-line forms to enable members of the public to input information (e.g., data to be included in the space mission) and to render payments (e.g., via credit cards, on-line accounts, virtual wallets or the like).

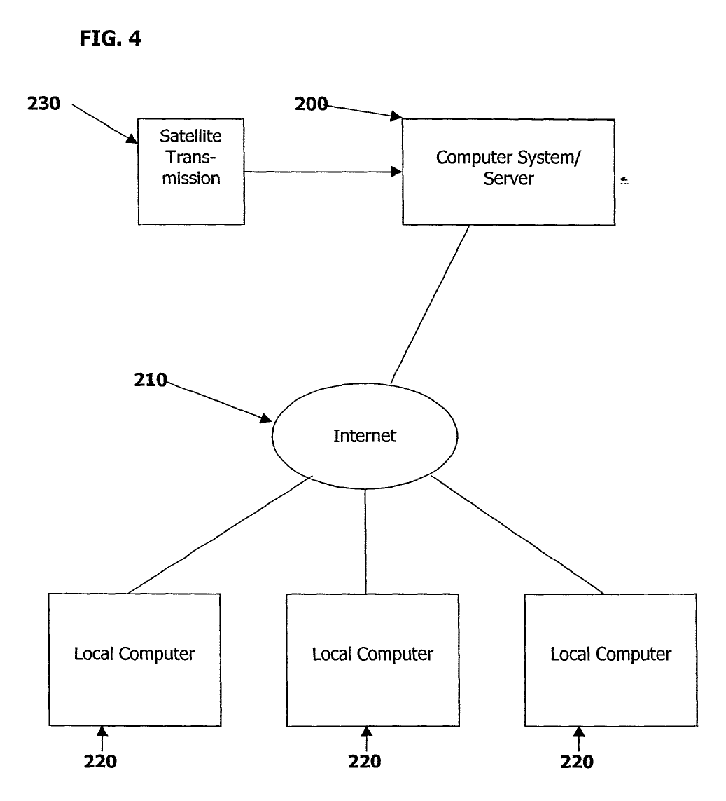

As shown in FIG. 4, preferably, a computer 200 (e.g., a server) is connected to the Internet or to another computer network 210 which hosts a web site or the like that is accessed over the Internet or other computer network 210 via a plurality of remote computers 220 (e.g., local computers such as home personal computers, business computers within local area networks, personal digital assistants, etc., utilizing web browser software or the like).

### On-line Registration, Etc.

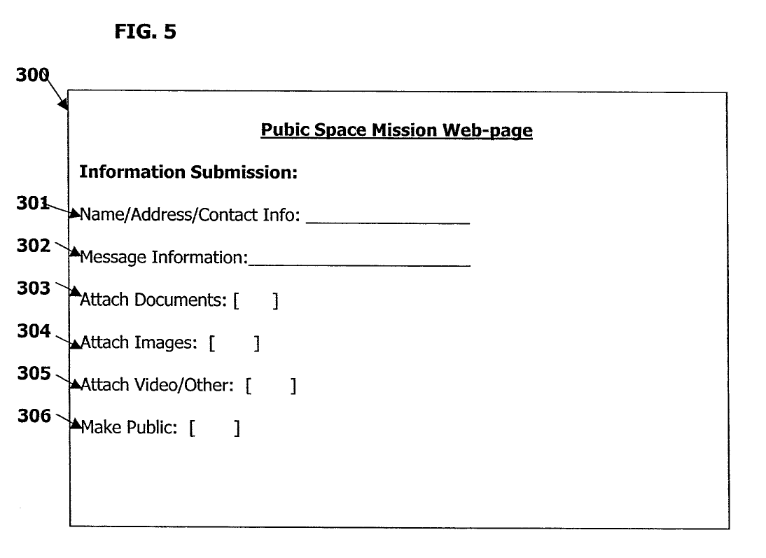

Preferably, the web site provides a number of ways for members of the public to participate in real space missions. As shown in FIG. 5, for example, a web page 300 can enable members of the public to sign up to become participants in the space mission. Preferably, the web page 300 includes a form for entering personal information 301 (e.g., name, address, contact information, e-mail address, billing information [e.g., credit card information, etc.] and the like) and message information 302 (e.g., written material such as a personal statement, a personal biography or another written statement) that is typed directly into a field on the electronic form to present such information for inclusion in a space mission, a means to attach documents 303 (e.g., via e-mail or other means), a means to attach images 304 (e.g., via e-mail or other means), and/or a means to attach video, audio or other material 305 and to submit the same electronically via the web site. Accordingly, the web site preferably enables members of the public to electronically submit information (e.g., to the server 200) that is to be included within a space mission. Any known means for inputting information can be used. The information is, thus, preferably able to be retrieved, managed and the like by the management and/or administrator of the web site. In addition, documents and the like can be translated as necessary to required formats for incorporation within a space mission based on circumstances.

In some exemplary embodiments, individuals can send (e.g., via e-mail) photographs as image data files to be incorporated into their submission. An e-mail can be enabled via a window or the like of the web site in some preferred embodiments. In some exemplary embodiments, photographs can be scanned into an electronic form and provided on the mission (i.e., either by individuals submitting such photographs or by the administrator of the web site).

As shown in FIG. 5, the web page also preferably includes a field 306 that a user can “click on” or the like to identify whether or not information or certain portions thereof may be made available for viewing by other individuals. In this manner, when a plurality of members make their information, statements or the like available to other individuals or to the public, the web site can include means to allow people to view, hear, etc., various statements or the like by other participants. Additionally, the web site could also include a search engine whereby statements of other participants can be word-searched or the like. In some cases, statements and the like may be retained within a secure section of the web site that can only be accessed by certain individuals. For example, in some cases, the statements can only be accessed by the management, administrator and/or the owner of the web site. As another example, in some cases, the statements and information submitted can be utilized for marketing purposes. In some cases, users can fill out forms with discrete sections for inputting their personal interests, hobbies, addresses, ages, etc. These forms are desirable for the participants (i.e., facilitating input) and are desirable for owners of the web site, the companies participating in the mission, etc. (i.e., for marketing and commercial purposes).

### Participant Control Via On-line Interface

In some preferred embodiments, the public participation includes an interactive interface between the spacecraft and the public participants in the space mission.

In preferred embodiments, a graphical user interface is provided over the Internet or World Wide Web that enables participants to submit selections or the like for controlling and/or otherwise interacting with the spacecraft.

Preferably, such transmissions are via the Internet. In some examples, the interactive interface can include means by which the participants can send or initiate the sending of transmissions to the spacecraft. In the latter case, transmissions to the spacecraft are preferably made indirectly. In one example, a user could access a web site or the like to send information back to an administrator of the web site, which may then send the information to the administrator of the spacecraft, which may then process the information and send appropriate control signals or the like to the space craft. The interactivity can include, for example, on-line control by participants of spacecraft. For example, participants may be able to a) control camera direction, camera focus or the like, b) control propulsion of the craft or other maneuvering operations thereof, c) control unfurling of a solar sail and/or of an advertisement, d) control on-board computers in some manner (e.g., to modify data files, to control displays, lights, or to perform other processing, etc.). The interactivity can also include on-line access to files and/or data on the spacecraft, such as, for example, wherein users can actually read and/or modify data files stored on the spacecraft via the Internet or the like. In some examples, the interactive interface can include means by which the participants can receive transmissions from the spacecraft, e.g., such as video, audio or other transmissions.

In some preferred embodiments, public participation is conducted in such a manner as to aggregate or group participant selections to create a single outcome. For example, in some embodiments, the web site can include a field at which participants can select one or more out of a larger number possible choices and an average selection, a most popular selection or the like can be used to control the space mission. For example, users could potentially select camera angles (e.g., of cameras mounted on the spacecraft, etc.), focal positioning of cameras, when to deploy certain elements such as a solar sail or another element of a spacecraft, etc. In addition to the aggregate method of selection, selection could be based on a lottery- or election type system in which a winner is chosen by chance, election or the like (e.g., in some cases, the participants themselves could each be given voting rights such that they can select one or more participant to be chosen). Alternatively, selection could be made based on a contest-type system in which a winner of a contest can be chosen. Alternatively, selection could be made based on a payment-type system (e.g., either a fixed rate or on an auction basis or the like) in which users pay for such an opportunity.

In some preferred embodiments, the participants can be granted a short period of time to participate. For example, individuals can potentially receive a short interval of participation time (e.g., a few minutes or another time period). These intervals could be sequential in time such that a large number of individuals can interact with the mission sequentially.

In addition to user control of spacecrafts, in other embodiments, certain aspects can be applied to land rovers (e.g., land traveling space vehicles such as the MARS LAND ROVER), rockets or carriercrafts that are launched from the earth's surface, or other crafts and/or vehicles utilized in space missions. For example, participants may be provided with on-line access to controls or the like of a land rover. In this latter case, participants in the space mission can preferably control activities of the land rover, such as controlling the direction of travel of the land rover over a surface of the moon, mars, or the like, controlling camera angles or the like. Once again, preferably user control would be made available via an on-line graphical user interface such as a web site accessed via the World Wide Web or the Internet.

### Additional On-line Features

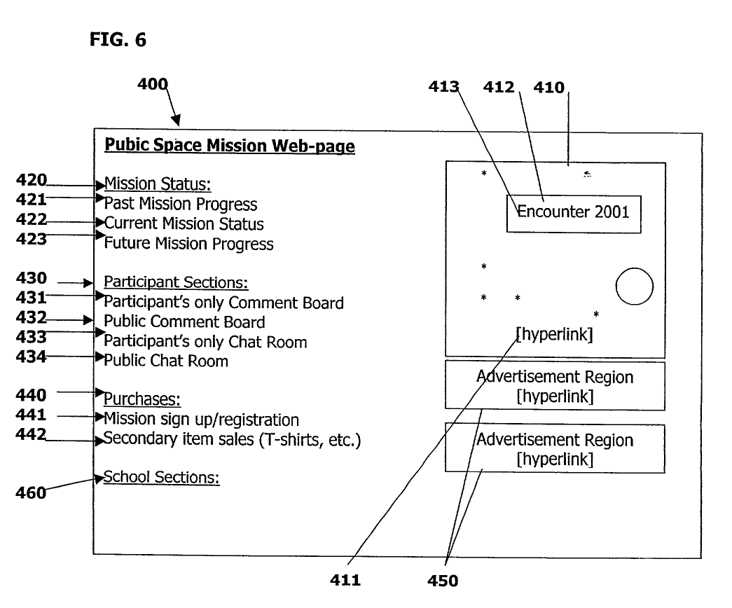

FIG. 6 is another illustrative web page that may be displayed on users' remote computers or the like. The web page shown in FIG. 6 includes a number of features that may be incorporated together or that may be used separately and individually. In preferred embodiments, on or more of the following on-line features can be made available to participants only and/or only to members of the public that pay (e.g., on-line via credit cards or other electronic payment means) to have access to or receive the feature(s).

### Web Casts, Etc.

As shown in FIG. 6, a field 410 is preferably provided for presenting a video image and/or a web cast of the space mission. As shown in FIG. 4, the space mission is preferably filmed (e.g., such as via remote cameras contained on a carriercraft or on the earth's surface or the like as discussed below) and video data is preferably transmitted back to the server 200, such as via a satellite transmission 230 and the like. Preferably, the field 410 provides substantially real-time images of a spacecraft during a predetermined time or event in a space mission. As shown, the field 410 also preferably includes embedded codes creating a hyperlink 411 to a particular address or uniform resource locator (URL) of another web site or the like. The other web site or the like is preferably that of a corporate sponsor or the like or that of an entity having an advertisement, image, logo or the like displayed on the spacecraft and viewable in the field 410. Accordingly, the field 410 is preferably scaled to enable viewing of a spacecraft 412 in a manner to allow a user to visually read an advertisement 413 on the periphery of the spacecraft. In one embodiment, the user can preferably hit a key or click on a region of the web page to cause the video image to zoom-in and/or zoom-out (i.e., to enlarge and/or reduce the size of the image). In this manner, a user can preferably have a far away view of the spacecraft as a small object in the sky or a close-up view of the spacecraft.

In some preferred embodiments, the field 410 or another field is used to present a web cast or a number of web casts in relation to a space mission—e.g., displaying various images in relation to the space mission and, if desired, including a corresponding audio component. The web cast may include a real-time “live” web cast of the launch of the mission, or of the separation of a spacecraft 412 from a carriercraft, or the like. The web cast may also include an announcer or host that is visually observable on the web page and/or that provides verbal commentary along with the web cast in a manner parallel to typical newscasts. In some embodiments, members of the public may be charged to view the space mission over the web cast. In some embodiments, the web cast can include a streaming media presentation that is transmitted to a local computer of a member of the public only after receipt of payment therefore, the payment being made on-line via credit card, virtual wallet or other electronic payment means. The playback of the streaming media can be carried out by a suitable streaming media player, which could be executing on the user's local computer as a plug-in module for a browser application. Some examples of suitable streaming media players include the MICROSOFT MEDIAPLAYER, the APPLE COMPUTER QUICKTBE and the REALVIDEO or REALPLAYER programs provided by REAL NETWORKS. In addition, the present invention could use other available streaming players.

### Mission Status, Etc.

As shown in FIG. 6, a region 420 is preferably provided to direct a viewer to other web pages or the like to obtain information regarding mission status. Preferably, a specific region 421 is provided for a user to “click on” to be presented with information related to past mission history and facts (e.g., including images of the voyage to date, information regarding the development of the mission, background information of the mission, technical information regarding the construction of the spacecraft, past flight path information of the mission, etc.). Preferably, a specific region 422 is provided for a user to “click on” to be presented with information related to present mission status and facts (e.g., including images of the present location of the mission, the specific distance of the spacecraft, the fuel remaining on the spacecraft, various other technical information of the spacecraft status, or the like). Preferably, a specific region 423 is provided for a user to “click on” to be presented with information related to anticipated future mission status and facts (e.g., including illustrations of the anticipated flight path and schedule, the anticipated development of the mission, etc.).

In some embodiments of the invention, the spacecraft is optically tracked via terrestrial telescopes (or, alternately, via non-terrestrial telescopes) during the space mission. Preferably, the optical image of the spacecraft is transmitted for viewing by the participants as described herein. In some preferred embodiments, the optical tracking is performed for a substantial period of time and is substantially continuously made available for viewing via an on-line web site, e.g., via a streaming media presentation or the like. For example, in some cases, the optical tracking can follow the spacecraft from deployment to a distance as far as Mars from the earth or even further.

In some embodiments, the spacecraft is tracked via radar during the space mission. Preferably, the location of the spacecraft is transmitted for viewing (e.g., on an on-line radar screen image) by the participants. Preferably, the radar tracking is performed for a very substantial period of time over the course of the mission. In this manner, mission status can be updated and/or viewed on a continuing basis.

### On-Line Communications, Etc.

Additionally, as shown in FIG. 6, the web page also preferably includes a region 430 for participant and/or public communication. Preferably, a region 432 is provided to enable members of the public to post comments on message boards in relation to space missions or the like. Preferably, a region 431 is provided to enable only certain members of the public having user identifications and/or passwords (e.g., alphanumeric identification codes) to view and/or post comments. Thus, in some embodiments, certain message boards can be limited to, for example, actual participants in the space missions.

Additionally, as shown in FIG. 6, the web page also preferably includes a region 434 to enable members of the public to “chat” on-line in substantially real-time about the space missions or the like. Most preferably, a region 433 is provided to enable only certain members of the public having user identifications and/or passwords (e.g., alphanumeric identification codes) to view and/or participate in certain chat sessions. Thus, in some embodiments, certain chat rooms or sessions can be limited to, for example, actual participants in the space missions. In some preferred embodiments, on-line discussions can include famous individuals, such as actors in films and other audiovisual works, such as science fiction films or the like, astronauts, spacecraft engineers and the like for greater user involvement.

The web site preferably also includes samples of the public participation information in archived form. For example, pictures of participants and their messages can preferably be viewed. In one embodiment, as noted herein, people can select whether or not to have their information viewable. In this latter case, in one exemplary embodiment thereof, information is submitted on the Internet and individuals can designate whether such information is to be made available for viewing by others over the internet.

In a participants only or members only section of the web site, there is preferably detailed information on the space mission(s), mission updates, a members only message boards participants can view the latest posts regarding upcoming events and activities, members only contests, and more. The web site also preferably includes a section for participants to submit on on-line form opinions, comments, questions and/or suggestions.

### Purchases And Additional Items, Etc.

As also shown in FIG. 6, the web page preferably also includes links to sections for making purchases 440. As shown, preferably, a link 441 is provided for members of the public to sign up and become actual participants in a space mission. This link 441 may include a link to a web page similar to that shown in FIG. 5 to enable the on-line submission of information. Preferably, a link 442 is also provided to direct users to regions to enable the purchasing of various secondary items, such as T-shirts, video disks, audio disks, caps, mugs, books, maps, watches, etc.

Preferably, the web site will enable the purchasing of secondary items before, during and/or after a mission. Preferably, the web site will provide contests that can be entered for participation over the Internet. Preferably, as noted, the web site will also provide other activities that can be participated in over the Internet (e.g., on-line discussions, meetings, lectures, chat sessions, etc.).

As shown, preferably, the website includes regions 450 for providing advertisements, such as banner advertisements. The advertisements preferably include hyperlinks to URLs of, for example, web sites for rendering purchases of products or services of an advertiser.

Preferably, the web site includes a region 460 for schools and/or other institutions to participate. The region 460 can provide links to web pages for enabling schools to sign up as participants, to web pages for enabling students to communicate together (e.g., in chat rooms or on message boards, and the like). The school participation sections are preferably secured behind a firewall requiring access via identification codes and/or password codes.

Preferably, upon signing up to participate in a space mission, participants are provided physical items related thereto (e.g., via mail)—such as, for example, kits, posters, membership cards, certificates, and other physical items. Preferably, some secondary items that can be purchased and/or that are provided to participants can include kits containing information about the mission and table top displays or wall mountable plaques.

### Spacecraft Cargo, Etc.

Preferably, the overall space mission is launched as a secondary payload. In one exemplary embodiment, it is included on an ARIANEE 5 rocket. In one example, the ARIANEE 5 rocket can be used to place a small spacecraft in geo-synchronous transfer orbit. At a certain point in time (e.g., coordinated with television broadcasting, web casting, etc.), the spacecraft can be propelled along a particular path—e.g., out of the earth's atmosphere.

Preferably, as noted, the public participation involves user participation by the submission of information and materials as cargo within a spacecraft. The spacecraft will preferably contain writings, drawings, photographs and/or other information or materials of more than about 250,000 individual participants, and, more preferably, more than about 500,000 individual participants, and, more preferably, more than about 1,000,000 participants, and, more preferably, more than about 1,500,000 participants. In some preferred embodiments, there will be between about 1.5 and 2.5 million participants. Preferably, participants pay less than about $100 for participation, and, more preferably, only about $50, or even less. (In view of changes in currency values, valuation should be proportional to values as of the filing date of this application). Preferably, there are multiple tiers of participation, whereby individuals can choose to participate in one or more ways—e.g., the submission of electronic data alone can be at a substantially lower rate than the submission of physical materials or samples, such as physical body samples containing DNA or other genetic information, actual physical photographs or materials, or the like. As another example, individuals could be charged a certain rate for a particular amount of memory or disk space used. For example, one individual could potentially pay substantially less to submit a paragraph of information, while another individual could pay substantially more to submit a long personal biography or the like. Preferably, in cases where DNA sample material is included, it is encased or the like and maintained sufficiently intact to allow for the possibility of cloning.

In addition to providing personal messages and/or personal DNA samples or the like, the public mission can include “group” public participation. For example, messages, pictures or images or the like of groups of individuals can be included. In addition, the mission can include a general information package to accompany all of the participant information, including, e.g., explanatory instructions, general information about the planet earth, general information about our culture and society and the like. In addition, non-human DNA material can be provided, such as that of other animals and/or plants. Preferably, the “general” information to be submitted can be “read” or “viewed” by members of the public via the web site provided over the Internet.

In another embodiment, radio or other forms of space broadcasts can be sent from the earth into space, either prior to the launch of the spacecraft (e.g., as a precursor thereto) or subsequent to the launch of the spacecraft (e.g., as a means to announce to distant worlds the coming of the spacecraft, to supplement information transmitted in the spacecraft, or the like). In this regard, preferably, individuals can submit information that is transmitted via a large scale radio-transmission-device away from the earth (e.g. via a large radio dish). Preferably, the transmission is in the direction of the travel of the spacecraft and/or includes information related to the spacecraft (e.g., such as its location, its path of travel, its contents, etc.). Preferably, the transmission is of sufficient magnitude to enable the radio transmission to travel for a distance of many light years—preferably, more than about 20 light years, and, more preferably, more than about 40 light years, and, more preferably, more than about 60 light years. In one illustrative embodiment, the information provided in such radio transmission can be submitted for transmission via the web site. As one illustrative example, users can input text into on-line forms to submit data for such transmissions.

Preferably, the medium upon which data is transported on the space mission is spaceworthy—e.g., having high viability in the presence of radiation, high temperature, temperature fluctuations, and outgassing. Preferably, the medium is small to minimize mass—e.g., preferably, only a few ounces. Preferably, the archival life enabled by the medium is long—e.g., thousands or many thousands of years. In one illustrative construction, the electronic data information to be included as cargo for transport in the space mission can be stored on a high density ROSETTA DISC provided by NORSAM TECHNOLOGIES, Los Alamos, N.Mex., e.g., a nickel disc which is written on using a charged electron and ion beam.

While preferred embodiments of the present invention relate to spacecraft, in some other embodiments, aspects of the present invention can be applied in other contexts. For example, in addition to that discussed above with respect to user control of space vehicles, certain aspects can be applied on land rovers (e.g., land traveling space vehicles such as the MARS LAND ROVER), rockets or carriercrafts that are launched from the earth's surface, or other crafts and/or vehicles utilized in space missions.

### Tying Space Missions To The Promotions Of Creative Audiovisual Works

According to preferred embodiments of the present invention, revenues are generated in space missions by uniquely tying space missions with the promotions of goods or services including, most preferably, specific creative audiovisual works such as movies, film, television programs, video and/or the like.

Preferably, advertisement space is sold to companies, corporations or other commercial entities that sell products and/or services to the general public or to sectors of the general public. In one illustrative application of the first embodiment, revenues are generated in relation to space missions by the sale of corporate billboards or the like advertisement space located on the physical spacecrafts themselves. These advertisements are preferably viewable via remote cameras (e.g., mounted on spacecraft carriers that deploy the spacecraft in the upper atmosphere or space or on reusable orbital platforms such as a space shuttle or a space station, etc.) or via terrestrial means such as earth-based telescopes or the like.

The present invention can thus provide a great incentive to corporate and the like sponsors, that hitherto had no reason to contribute to space missions, to participate as significant sources of revenue by purchasing spacecraft advertisements and sponsorship of space missions.

Moreover, tying corporate advertisements to specific creative audiovisual works and the like, greatly enhances the ability of generating revenues via corporate advertising and sponsorship.

In some preferred embodiments of the invention, the advertisements (e.g., preferably displayed on the exterior of the spacecraft) provide promotions of creative works including audio and visual/video components, such as, for instance, one or more of the following: movies, film and/or motion pictures (e.g., STAR WARS, MEN IN BLACK, ALIENS or any other movie or motion picture); television programs or shows (e.g., STAR TREK, THE X-FILES, or any other program or the like); videos (e.g., various movie or other video releases); creative webcasts or Internet broadcasts.

In preferred embodiments of the invention, the advertisements are for commercial entities that sell such products or services to the public. In more preferred embodiments of the invention, the advertisements provide promotions of products that are purchased by actual participants in the space mission. For example, where the space mission includes an educational aspect, the advertisements may be for companies that sell substantially to school children or for products sold substantially to school children, such as rated G movies (e.g., DISNEY movies and the like), as well as clothing (e.g., jeans, shoes and sneakers), sporting goods or the like.

In some embodiments, the advertisements can include: a company name (e.g., ENCOUNTER 2001, LLC as shown, or PARAMOUNT PICTURES or the like); a company logo (e.g., such as a picture of a LION or the like); a company slogan (e.g., such as “I'LL BE BACK” or the like); an image of a famous individual such as a company spokesperson or an actor in a film or the like; an offer made by the company to its consumers (e.g., “buy one get one free” or the like); sale information provided by the company to its consumers (e.g., “end of the millennium sale” or the like); a company web page address, URL or other computer accessible user interface address (e.g., http://www.encounter2001.com); and/or any other company identifiers or information to be provided to its consumers.

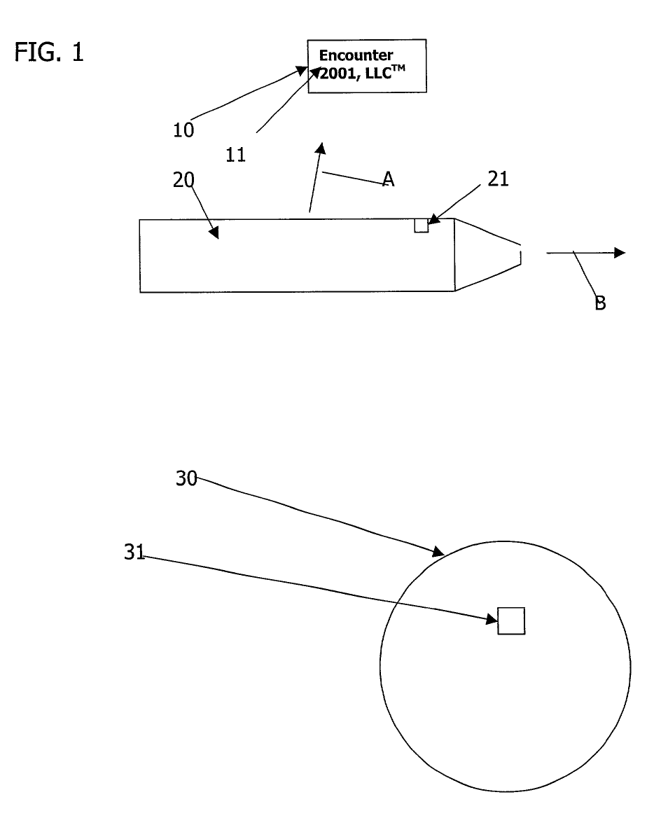

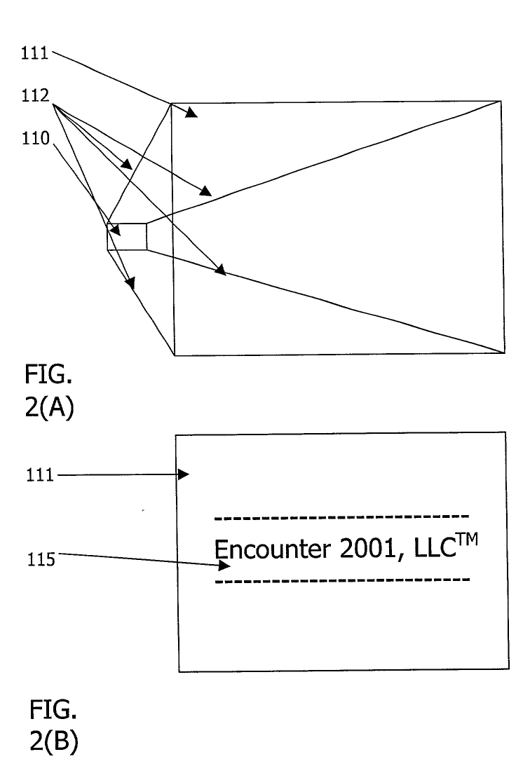

FIGS. 1, 2(A) and 2(B) illustrate some exemplary, and non-limiting, methods of providing space mission advertisements for commercial entities. With reference to FIG. 1, according to a first preferred embodiment of the invention, a spacecraft 10 is provided with a region on an external surface thereof for one or more advertisement. In the illustrated embodiment, the advertisement reads “Encounter 2001, LLCTM™.”

In the embodiment shown in FIG. 1, the spacecraft 10 follows a path A away from and out of the earth's atmosphere. As also shown in FIG. 1, the spacecraft 10 is preferably initially mounted upon a carriercraft 20 that is designed to carry the spacecraft to a predetermined altitude (e.g., from within the earth's atmosphere into outer space) and to then deploy the spacecraft 10. In the embodiment of FIG. 1, the carriercraft 20 may follow, e.g., a path B generally transverse to the path A of the spacecraft. The carriercraft 20 can include, for example, a rocket, a reusable orbital platform or another carriercraft.

Preferably, the spacecraft is launched as a secondary payload. In one exemplary embodiment, it is included on an ARIANEE 5 rocket. In one example, the ARIANEE 5 rocket can be used to place a small spacecraft in geo-synchronous transfer orbit. At a certain point in time (e.g., coordinated with television broadcasting, web casting, etc.), the spacecraft can be propelled along a particular path—e.g., out of the earth's atmosphere.

Alternatively, the spacecraft 10 can follow any known trajectory or path. In just one of many illustrative embodiments, the spacecraft may be sent on a trajectory away from our planet's solar system. In one illustrative example, the spacecraft 10 may initially be launched into an earth geo-synchronous transfer orbit (GTO) as an intermediate orbit. Then, the spacecraft 10 may be propelled by an internal rocket motor to another planet, e.g., Jupiter, to use the planet's gravity to boost itself on a trajectory outside of the solar system. The spacecraft 10 can also be directed into other known trajectories, such as into orbit around the earth, around the sun or along another path.

As shown in FIG. 1, the spacecraft is uniquely adapted so as to include an advertisement 11 on the external surface thereof. In the preferred embodiment, this advertisement is mounted in such a manner to enable viewing of the advertisement upon deployment of the spacecraft 10 from the carrier 20. That is, the advertisement 11 is, in some preferred embodiments, viewable upon deployment of the spacecraft 10—and, in preferred embodiments, not upon the initial launch of the carrier 20 (e.g., typically from the earth's surface).

Accordingly, a spectacular advertisement can be created that is viewed in space. The image of the advertisement in space is most preferably transmitted to numerous consumers of goods or services sold by the advertising entity, and most preferably, in substantially real time.

In one preferred embodiment, the advertisement 11 is viewed via a video camera 21 supported by the carriercraft 20. In this latter embodiment, the system preferably sends signals to the earth for viewing. In this case, the advertisement position on the spacecraft, the video camera 21 location and the deployment of the spacecraft 10 should be coordinated so that the video camera 21 will have a substantially direct view of the advertisement 11 for a period of time to allow viewing during deployment. Preferably, in some embodiments, the video transmission is broadcasted in substantially real time for television viewing. Preferably, in some embodiments, the video transmission is additionally or alternatively transmitted over a computer network for access by consumers of the advertised products or services via their personal computers or the like, such as over the Internet or the World Wide Web. This Internet or webcast transmission is most preferably performed in substantially real time. In the latter case, the video transmission may be limited to smaller video clips or pictures where transmission bandwidth is limited. When an advertisement is displayed on the Internet, a web page or the like displaying the advertisement may also be provided with a link to an address, e.g., via a uniform resource locator (URL), of a web page of the advertising entity to direct the consumers to render purchases or to receive additional information. In some embodiments, the web cast can include a streaming media presentation that is transmitted to a local computer of a member of the public only after receipt of payment therefore, the payment being made on-line via credit card, virtual wallet or other electronic payment means. The playback of the streaming media can be carried out by a suitable streaming media player, which could be executing on the user's local computer as a plug-in module for a browser application. Some examples of suitable streaming media players include the MICROSOFT MEDIAPLAYER, the APPLE COMPUTER QUICKTIME and the REALVIDEO or REALPLAYER programs provided by REAL NETWORKS. In addition, the present invention could use other available streaming players.

Preferably, the website also provides video imaging to enable users to follow the progress of the mission—e.g., from the design, to the construction, to the launch of the space craft and/or to the spacecrafts deployment from a carriercraft or departure from the solar system. Corporate sponsors having advertisements on the spacecraft may, thus, even generate advertising for many years after the initial launch and broadcasting, by maintaining video imaging and progress information in relation to the ongoing mission.

In another preferred embodiment, as shown in FIG. 1, the advertisement can be viewable from earth 30, e.g., via an earth-based telescope 31. In some preferred embodiments, the telescope 31 can be a large commercial telescope and images obtained therewith can be recorded and transmitted—as in the preceding embodiment—to consumers via television broadcasting, Internet broadcasting and/or other forms of image broadcasting. Moreover, the images can also be reproduced within newspapers, magazines, and other materials. Moreover, the images can also be reproduced onto assorted secondary items such as T-shirts, coffee mugs, plates, posters and other displayable novelty items.

FIGS. 2(A) and 2(B) illustrate one preferred embodiment of the invention wherein a spacecraft 100 is used that includes a solar sail 111. In this latter embodiment, the advertisement 115 is most preferably located on the solar sail 111. As is known in the art, solar sails can be used to power spacecraft via reflection of solar and the like radiation. See, e.g., U.S. Pat. No.: 5,850,992 (Method for Controlling the Pitch Attitude of a Satellite By Means of Solar Radiation); U.S. Pat. No. 5,183,225 (Spacecraft That Utilizes Sight Pressure and Method of Use); U.S. Pat. No. 4,909,460 (Device and Method for Aiming a Space Probe Toward a Celestial Body); U.S. Pat. No. 4,759,517 (Station-Keeping Using Solar Sailing); U.S. Pat. No. 4,614,319 (Solar Sail), the entire disclosures of which are incorporated herein by reference. Solar sails may be made with expansive surface areas—e.g., multiple kilometers in width—upon which very large advertisements can be displayed. In some embodiments, the solar sails could potentially be viewable by consumers or laymen with moderate telescopes, binoculars or the like; in these latter embodiments, the advertisements would have very substantial visual impact upon the viewing consumers of the products or services sold by the advertising entity.

### Multiple Revenue Sources

According to another embodiment of the present invention, revenues are preferably generated in relation to space missions from a variety of revenue sources. Hitherto, the number of revenue sources was limited.

According to embodiments of the invention, a number of revenue sources are made available in relation to space missions. In addition, the present invention can significantly increase proceeds received via various existing revenue sources.

### Public Participation Revenue Sources

In the most preferred embodiments of the invention, the spacecraft 10, 100 is a utilized, at least in part, for a public participation space mission. Preferably, members of the public can render payments in order to act as participants in the space mission. For example, by contributing $X dollars, members of the public may be able to provide data, images, statements, material, objects or other information or the like of individual consumers that is carried within the spacecraft 10, 100. In this manner, the public consumers should have a heightened personal interest in the space mission, greatly enhancing advertisement value for the advertising companies. Preferably, the public participation component of the space mission is only one component of the entire space mission. For example, the carriercraft 20 preferably contains government, scientific and/or other cargo, experiments and the like. Accordingly, the present invention provides a significant means for defraying costs in space missions, benefiting all entities utilizing the carriercraft.

In some preferred embodiments, an Internet web site or other on-line graphical user interface is provided which provides on-line entry forms with which members of the public can input information (e.g., data to be included in the space mission) and can render payments (e.g., via credit cards, on-line accounts, virtual wallets, or the like). Preferably, the web site also includes links or pages for rendering purchases for secondary items and/or links or pages for purchasing goods or services, e.g., movie tickets or the like, sold by commercial advertisers or sponsors of the space mission.

In some preferred embodiments, an Internet website or the like can be provided with a web cast (e.g., a streaming media presentation or the like) of the space mission and members of the public can render payments (e.g., preferably on-line) to be provided with such a web casting. In this manner, revenues can be generated by, for example, providing a pay-per-view type of Internet-based or web-based broadcast. In some embodiments, the web cast can be made available only to members of the public that are participants in the mission; in this latter case, the original participation fee may include the costs for viewing web casts and/or additional charges can be incurred to view certain web casts.

In one embodiment, a member of the general public, and most preferably a customer participating in a public participation component of a space mission, may be selected and/or may render payment to perform a pre-determined task in relation to the space mission—such as, for example, pressing a button that actuates a stage in the technical process of the space mission, such as launch of the spacecraft from a carriercraft, initiation of propulsion of the spacecraft, initiation of broadcasting of video images from a camera showing the spacecraft or participation in another space mission technical process.

### Corporate Participation Revenue Sources

As set forth herein, the present invention enables corporate and the like sponsors to participate via spacecraft advertisements and sponsorship of space missions.

The unique methods of corporate advertisement—e.g., advertisement by corporations that sell products or services, including audiovisual works, to the public (e.g., especially to members of the public that are actual participants in the space mission)—greatly enhance the ability to generate revenues via corporate advertising and sponsorship.

### Educational Revenue Sources

In some embodiments, an education component can be provided to supplement capital investment and publicity strategies.

For example, primary sales (e.g., sales of public participation features, etc.) and secondary product sales (e.g., sales of T-shirts and various other secondary items) can be greatly stimulated by incorporating educational components—and especially educational components wherein public individuals are actual participants. While this educational aspect should greatly increase participation by school children, and in certain cases college students, it should also increase participation by family members, friends and other members of the public.

Moreover, revenues should also be greatly increased through corporations and the like that will benefit by the strong publicity involved in its sponsorship of a space mission incorporating such educational initiatives.

In some exemplary embodiments, one or more school can place a small experiment on board the spacecraft. In addition, revenues sources can be generated through educational contests in relation to space missions. In some preferred embodiments, a competition or contest can be established for a chosen school to place a small experiment on the spacecraft.

In some preferred embodiments, the educational component includes a website that includes one or more of a number of aspects in relation to the educational component. First, the website can include forms and other information to enable students, schools and/or other entities to obtain contest rules, etc., and to sign up and/or submit entries for a contest or the like. Second, the website can include educational information related to the educational component, such as a description of an experiment to be conducted and the principles related thereto. Third, the website can include an interface for students and/or other individuals to communicate within on-line chat rooms in relation to the space mission. Fourth, the website can be provided with a data-stream directly from the spacecraft itself to a web site server computer (e.g., transmitted via satellite communication or the like and then via the Internet or other network).

In the latter example, the data-stream can include, for example, substantially real-time data related to results of the educational component, such as results of an experiment. Moreover, the data could also include video or picture images of the educational component. Accordingly, students and/or the general public may be able to view the educational component (preferably, aspects thereof demonstrating degree of success or failure of an educational experiment or the like). In some embodiments, the data delivered from the spacecraft can be retrieved by (e.g., at a particular web page or URL) or transmitted to (e.g., via e-mail or the like) the participants in the experiment for further analysis in relation thereto. Additionally, a contest could be created that is awarded to the first school or the like to appropriately analyze the transmitted data. Additionally, in various embodiments discussed herein involving prizes, rather than awarding one prize, a number of prizes could be awarded so as to have a large number of winners. For example, all or most participants or all participants that successfully analyze the experiment within a time period or the like may receive coupons (e.g., from a sponsor), novelty items or other materials (e.g., from a sponsor) or the like.

Additionally, an educational component can also include class room or the like kits or distribution materials, such as, for example, a teachers' guide, and introductory letter, membership materials for students, posters, forms for the students to fill in or the like. Preferably, the students can submit information that may be displayed on the website in relation to participant team information (e.g., photographs, names or the like). Among other things, the website can serve not only to publicize the educational initiative, but it can provide a low cost means to distribute curriculum materials to schools.

### Sporting Space Mission Revenue Sources

In another preferred embodiment, the spacecraft 10, 100 can be a craft used in a spacecraft race. Preferably, the spacecraft race is between multiple solar sail powered spacecraft. The spacecraft race can be, for example: a) a race around another planet, e.g., mars or another planet; b) a race around the moon; c) a race around the earth; or c) a race along another desired race flight path. The spacecraft race may alternatively be a race to be the first spacecraft to achieve a particular task—e.g., such as the first solar sail spacecraft to successfully fly a particular distance, or to orbit the moon, or to orbit mars or the like. This latter form of “race” would attract significant media attention in a manner parallel to the media attention received by various individuals seeking to sail in a balloon around the circumference of the earth. Revenues can be generated in relation to sales of corporate sponsorship for the race, by sales of secondary race items (e.g., T-shirts and the like), and other means capitalizing on the media attention thereof. Additionally, gambling revenues, where legal, can be generated by hosting betting in relation to such races. In the latter case, preferably, an on-line betting web site is provided where members of the public can enter bets and render payments.

### Other Known Revenue Sources

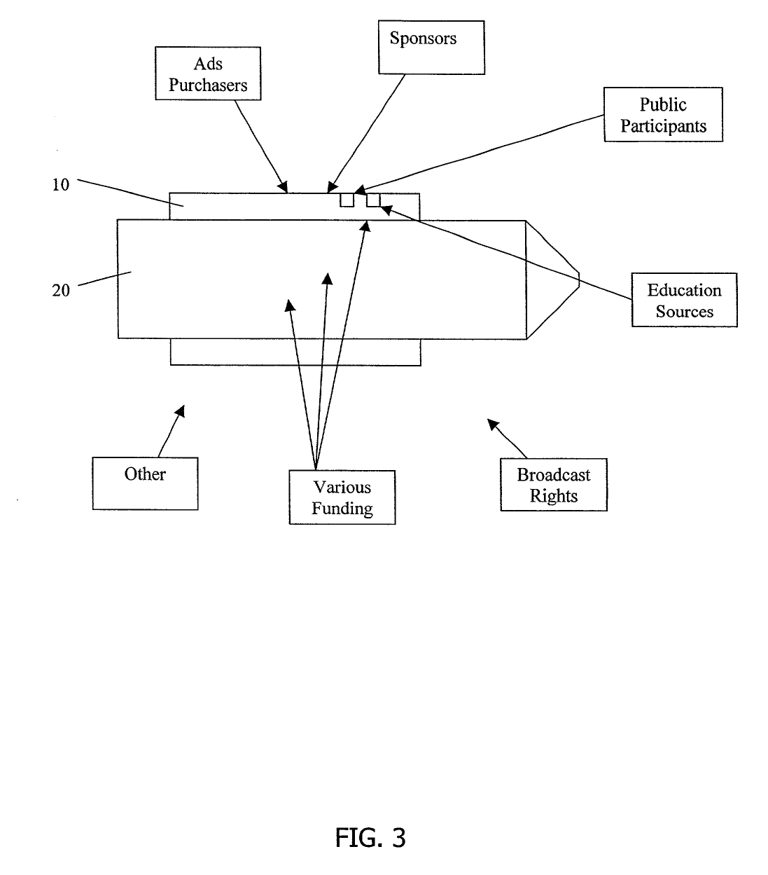

As in many existing space missions, revenues can also be generated via scientific institution participation, government participation in the space mission, and/or via any other means known for generating revenues in relation to space missions. It should be understood by those in the art, as illustrated schematically in FIG. 3, that all or some of the various revenue source components of the space mission described herein can be combined together in a single space flight mission.

While the present invention has been described above with respect to preferred embodiments of the invention, the present invention is not limited thereto, but encompasses all other modifications, variations and embodiments that would be apparent to those in the art based on this disclosure.

What is claimed is:

1. A method of public participation in a space mission, comprising:
a) providing a web site or other graphical user interface for members of the public to access via the Internet or another computer network;
b) having a public participant input data via a dynamic web page of the web site;
c) altering a mission of a space vehicle in response data received as input from the public participant.

2. The method of claim 1, wherein the altering of the mission includes incorporating data input by the public participant into a medium that is placed on the space vehicle.

3. The method of claim 1, wherein the altering of the mission includes controlling an aspect of the space vehicle.

4. The method of claim 1, wherein the space vehicle is a spacecraft.

5. The method of claim 1, wherein having the public participant input data includes having the participant enter textual data in an on-line form.

6. The method of claim 1, wherein having the public participant input data includes having the participant click or select a particular region of a display.

7. A method of public participation in a space mission, comprising:
a) providing a server programmed to create a web site or graphical user interface accessible via the Internet or a computer network;
b) providing a spacecraft having a public participation section;
c) obtaining video images of said spacecraft during travel of said spacecraft on a space mission;
d) creating an Internet or computer network broadcast of said video images;
e) having a member of the public access and view said broadcast via a local computer over the Internet or computer network.

8. A method of public participation in a space mission, comprising:
a) providing a server programmed to create a web site or graphical user interface accessible via the Internet or a computer network;
b) having a member of the public access the web site via the Internet or computer network at a local computer remote from the server;
c) having said member of the public input information via said web site;
d) providing a spacecraft having a public participation section;
e) physically storing said information submitted by said member of the public in said public participation section of said space craft; and
f) launching said spacecraft away from the earth's surface.

9. The method of claims 7 or 8, further including providing personal data and/or material of individual participants physically inside said section of the spacecraft for said public participation.

10. The method of claim 7, further including providing personal body material for said public participation.

11. The method of claim 10, wherein said personal body material includes hair or skin samples.

12. The method of claim 10, wherein said personal body material includes DNA samples.

13. The method of claim 9, further including providing photo and/or video images for the public participation.

14. The method of claims 7 or 8, including launching the spacecraft on a path out of the earth's atmosphere.

15. The method of claims 7 or 8, including launching the spacecraft on a path out of the earth's solar system.

16. The method of claims 7 or 8, including launching the spacecraft on a path in orbit around the sun.

17. The method of claim 9, further including providing information in the form of data stored on a computer readable medium for the public participation.

18. The method of claim 17, wherein the computer readable medium is a computer disk.
